(19) United States
(12) Patent Application Publication
(10) Pub. No.: US 2010/0013410 A1
(43) Pub. Date: Jan. 21, 2010

(54) POWER CONTROL DEVICE FOR A LOAD, AND LIGHTING ASSEMBLY HAVING THE SAME

(76) Inventor: Hui-Hung Wu, Taichung County (TW)

Correspondence Address: OCCHIUTI ROHLICEK & TSAO, LLP, 10 FAWCETT STREET, CAMBRIDGE, MA, 02138, US

(21) Appl. No.: 12/174,966

(22) Filed: Jul. 17, 2008

(51) Int. Cl. H05B 37/02

(52) U.S. Cl. 315/294

(57) ABSTRACT

A power control device includes a switch unit coupled in series to a load that has a rated power consumption and that is supplied with power from an external power source, and the power source. A current detecting unit is coupled to the load and outputs a detector signal corresponding to a detected current flowing through the load. A processing unit receives the detector signal from the current detecting unit, and processes the detector signal so as to output a power indicating signal that varies with a consumed power of the load. A control unit controls conduction times of the switch unit based upon the power indicating signal from the processing unit and a predetermined standard criterion corresponding to the rated power consumption of the load such that the detected current corresponds to the rated power consumption of the load.

### BACKGROUND OF THE INVENTION

1. Field of the Invention

The invention relates to a power control device, more particularly to a power control device for a load, and a lighting assembly having the same.

2. Description of the Related Art

A conventional lamp device includes a set of lamps. When lamps having higher power consumption are used in the conventional lamp device, a total consumed power of the conventional lamp device increases and can even exceed a rated power consumption of the conventional lamp device. Therefore, such a lamp device is unable to pass certain government safety regulations.

### SUMMARY OF THE INVENTION

Therefore, an object of the present invention is to provide a power control device for a load and a lighting assembly having the same that can overcome the aforesaid drawbacks of the prior art.

According to one aspect of the present invention, there is provided a power control device for a load that has a rated power consumption and that is supplied with power from an external power source. The power control device comprises:

a switch unit adapted to be coupled in series to the load and the external power source;

a current detecting unit adapted to be coupled to the load, the current detecting unit outputting a detector signal corresponding to a detected current flowing through the load;

a processing unit for receiving the detector signal from the current detecting unit and for processing the detector signal so as to output a power indicating signal that varies with a consumed power of the load; and

a control unit coupled to the processing unit and the switch unit, the control unit receiving the power indicating signal from the processing unit and controlling conduction times of the switch unit based upon the power indicating signal and a predetermined standard criterion corresponding to the rated power consumption of the load such that the detected current corresponds to the rated power consumption of the load.

According to another aspect of the present invention, a lighting assembly comprises:

a lamp device that has a rated power consumption and that is adapted to be supplied with power from an external power source; and

a power control device including
a first switch unit adapted to be coupled in series to the lamp device and the external power source,
a current detecting unit coupled to the lamp device and outputting a detector signal corresponding to a detected current flowing through the lamp device,
a processing unit for receiving the detector signal from the current detecting unit and for processing the detector signal so as to output a power indicating signal that varies with a consumed power of the lamp device, and
a control unit coupled to the processing unit and the first switch unit, the control unit receiving the power indicating signal from the processing unit and controlling conduction times of the first switch unit based upon the power indicating signal and a predetermined standard criterion corresponding to the rated power consumption of the lamp device such that the detected current corresponds to the rated power consumption of the lamp device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating the preferred embodiment of a lighting assembly according to the present invention;

FIG. 2 is a schematic electrical circuit diagram illustrating a first switch unit, a current detecting unit and a processing unit of the preferred embodiment;

FIG. 3 is a schematic electrical circuit diagram illustrating a control unit and an input unit of the referred embodiment; and

FIG. 4 is a schematic electrical circuit diagram illustrating a second switch unit of the preferred embodiment.

### DETAILED DESCRIPTION OF THE PREFERRED EMBODIMENT

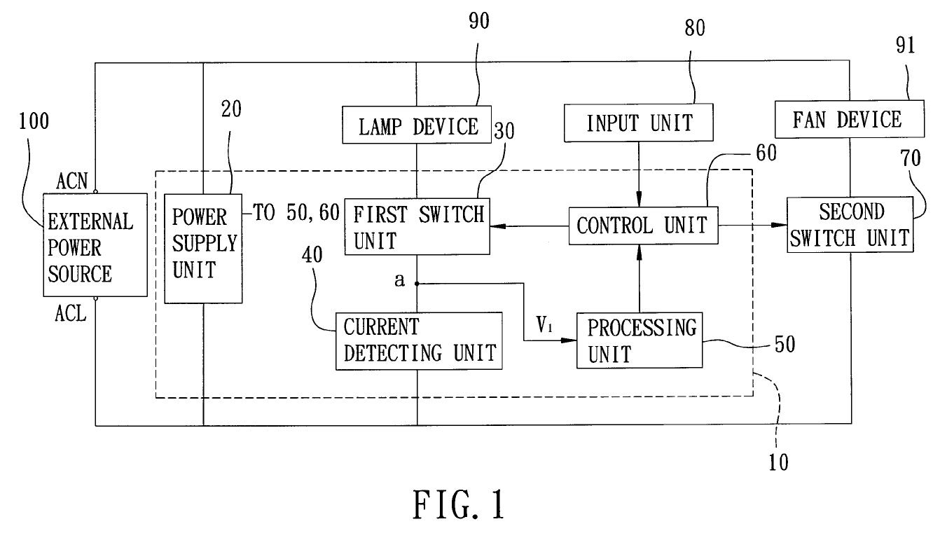

Referring to FIG. 1, the preferred embodiment of a lighting assembly according to the present invention is shown to include a lamp device 90, a power control device 10, a fan device 91, a second switch unit 70, and an input unit 80.

The lamp device 90, which serves as a load, has a rated power consumption, and is adapted to be supplied with power from an external power source 100, which is a commercial AC power source in this embodiment.

The power control device 10 includes a first switch unit 30, a current detecting unit 40, a processing unit 50, a control unit 60, and a power supply unit 20.

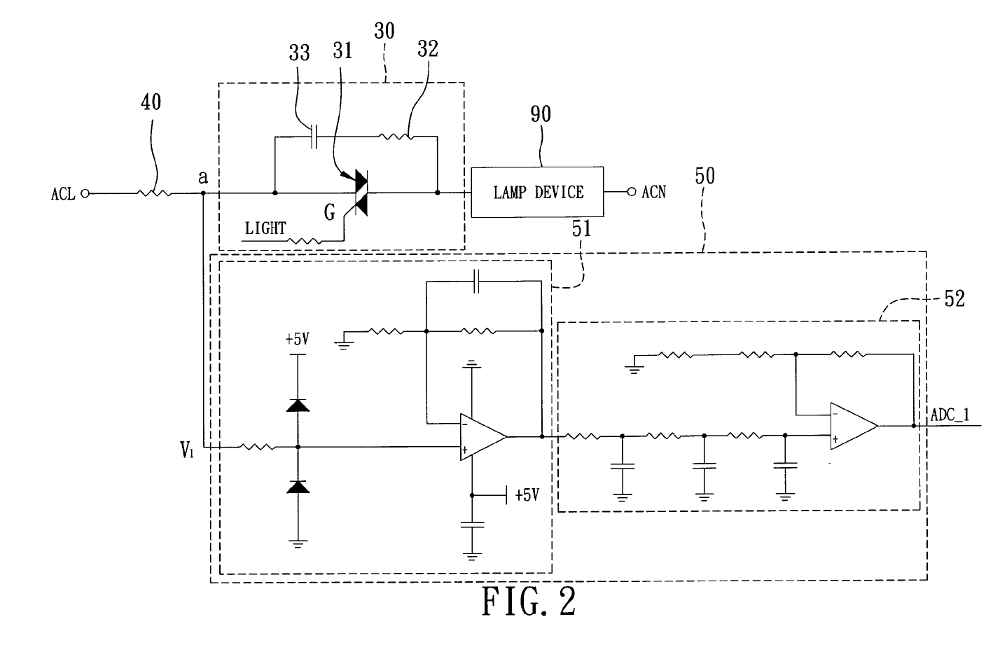

The first switch unit 30 is adapted to be coupled in series to the lamp device 90 and the external power source 100. In this embodiment, referring further to FIG. 2, the first switch unit 30 includes a series connection of a resistor 32 and a capacitor 33, and a triac 31 coupled in parallel to the series connection of the resistor 32 and the capacitor 33 and having a gate (G).

The current detecting unit 40 includes a resistor in this embodiment (see FIG. 2), is coupled to the lamp device 90 via the first switch unit 30, and is adapted to be coupled to the external power source 100. The current detecting unit 40 outputs a detector signal (V₁) corresponding to a detected current flowing through the lamp device 90. In this embodiment, the detected current is an AC current, and the detector signal (V₁) is an AC signal.

The processing unit 50 is coupled to a node (a) between the first switch unit 30 and the current detecting unit 40 for receiving the detector signal (V₁) from the current detecting unit 40 and for processing the detector signal (V₁) so as to output a power indicating signal that varies with a consumed power of the lamp device 90. In this embodiment, as shown in FIG. 2, the processing unit 50 includes a sampling circuit 51 and an average-value calculating circuit 52. The sampling circuit 51 is coupled to the current detecting unit 40 and samples the detector signal (V₁) from the current detecting unit 40 so as to generate a sampling signal, wherein the sampling circuit 51 samples a positive half-cycle of the detector signal (V₁). The average-value calculating circuit 52 is coupled to the sampling circuit 51 for receiving the sampling signal from the sampling circuit 51 and for outputting the power indicating signal, which indicates an average value of the sampling signal.

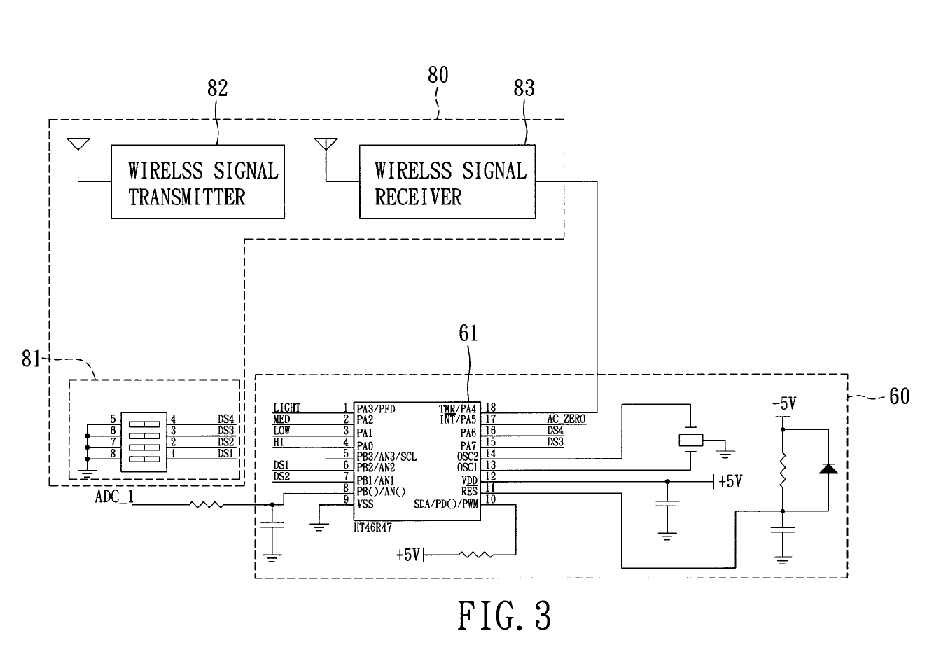

The control unit 60 is coupled to the average-value calculating circuit 52 of the processing unit 50 and the first switch unit 30. The control unit 60 receives the power indicating signal from the processing unit 60, and controls conduction times of the first switch unit 30 based upon the power indicating signal and a predetermined standard criterion corresponding to the rated power consumption of the lamp device 90 and stored in the control unit 60 such that the detected current flowing through the lamp device 90 corresponds to the rated power consumption of the lamp device 90. In this embodiment, referring further to FIG. 3, the control unit 60 includes a processor 61, such as a HT46R47 IC, having analog-to-digital conversion functionality. More specifically, the processor 61 is coupled to the average-value calculating circuit 52 of the processing unit 50 and the gate (G) of the triac 31 of the first switch unit 30. As a result, once the consumed power of the lamp device 90 is greater than the rated power consumption, the conduction times of the first switch unit 30 are reduced through control of the power control device 10, thereby ensuring that the consumed power of the lamp device 90 does not exceed the rated power consumption of the lamp device 90.

The power supply unit 20 is adapted to be coupled to the external power source 100 for receiving the power therefrom, and outputs a DC power to the processing unit 50 and the control unit 60.

The fan device 91 is adapted to be supplied with power from the external power source 100.

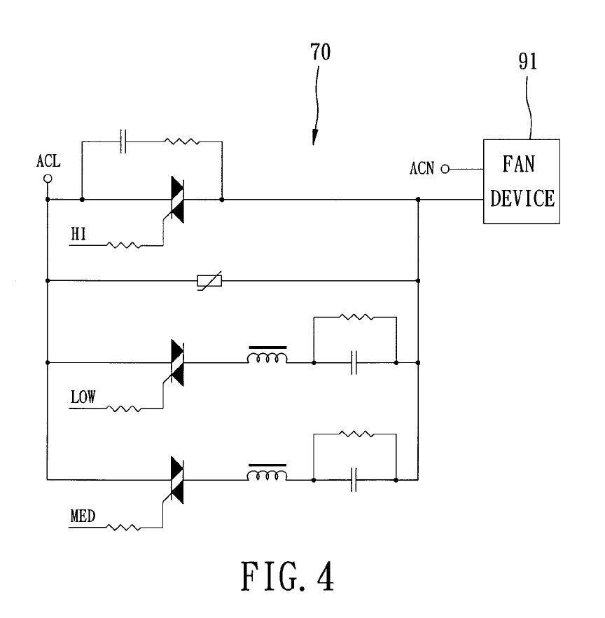

The second switch unit 70 is coupled to the fan device 91 and the control unit 60, and is adapted to be coupled to the external power source 100. Referring further to FIGS. 3 and 4, the second switch unit 70 includes three triacs each has a gate coupled to the processor 61.

The input unit 80 is coupled to the control unit 60, and is operable so as to provide an input signal to the control unit 60. In this embodiment, as shown in FIG. 3, the input unit 80 includes a mechanical switch unit 81 coupled to the processor 61 of the control unit 60, a wireless signal transmitter 82, and a wireless signal receiver 83 coupled to the processor 61 of the control unit 60 and operably associated with the wireless signal transmitter 82, wherein one of the mechanical switch unit 81 and the wireless signal receiver 83 generates the input signal.

It is noted that the control unit 60 is further operable to control conduction times of the second switch unit 70 in accordance with the input signal from the input unit 80, thereby controlling operation of the fan device 91. More specifically, the control unit 60 controls a rotation speed of a fan motor (not shown) of the fan device 91 in accordance with the input signal from the input unit 80.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A power control device for a load that has a rated power consumption and that is supplied with power from an external power source, said power control device comprising:
a switch unit adapted to be coupled in series to the load and the external power source;
a current detecting unit adapted to be coupled to the load, said current detecting unit outputting a detector signal corresponding to a detected current flowing through the load;
a processing unit for receiving the detector signal from said current detecting unit and for processing the detector signal so as to output a power indicating signal that varies with a consumed power of the load; and
a control unit coupled to said processing unit and said switch unit, said control unit receiving the power indicating signal from said processing unit and controlling conduction times of said switch unit based upon the power indicating signal and a predetermined standard criterion corresponding to the rated power consumption of the load such that the detected current corresponds to the rated power consumption of the load.

2. The power control device as claimed in claim 1, further comprising a power supplying unit adapted to be coupled to the external power source for receiving the power therefrom and for outputting a DC power to said processing unit and said control unit.

3. The power control device as claimed in claim 1, wherein said switch unit is adapted to be coupled to the load, and is coupled to said current detecting unit, said processing unit being coupled to a node between said switch unit and said current detecting unit.

4. The power control device as claimed in claim 3, wherein said current detecting unit includes a resistor.

5. The power control device as claimed in claim 1, wherein said processing unit includes:
a sampling circuit coupled to said current detecting unit and sampling the detector signal from said current detecting unit so as to generate a sampling signal; and
an average-value calculating circuit coupled to said sampling circuit and said control unit for receiving the sampling signal from said sampling circuit and for outputting the power indicating signal, which indicates an average value of the sampling signal, to said control unit.

6. The power control device as claimed in claim 5, wherein the detected current flowing through the load is an AC current, the detector signal is an AC signal, and said sampling circuit samples a positive half-cycle of the detector signal.

7. The power control device as claimed in claim 1, wherein said switch unit includes a series connection of a resistor and a capacitor, and a triac coupled in parallel to said series connection of said resistor and said capacitor and having a gate coupled to said control unit.

8. A lighting assembly comprising:
a lamp device that has a rated power consumption and that is adapted to be supplied with power from an external power source; and
a power control device including
a first switch unit adapted to be coupled in series to said lamp device and the external power source,
a current detecting unit coupled to said lamp device and outputting a detector signal corresponding to a detected current flowing through said lamp device,
a processing unit for receiving the detector signal from said current detecting unit and for processing the detector signal so as to output a power indicating signal that varies with a consumed power of said lamp device, and
a control unit coupled to said processing unit and said first switch unit, said control unit receiving the power indicating signal from said processing unit and controlling conduction times of said first switch unit based upon the power indicating signal and a predetermined standard criterion corresponding to the rated power consumption of said lamp device such that the detected current corresponds to the rated power consumption of said lamp device.

9. The lighting assembly as claimed in claim 8, wherein said power control device further includes a power supplying unit adapted to be coupled to the external power source for receiving the power therefrom and for outputting a DC power to said processing unit and said control unit.

10. The lighting assembly as claimed in claim 8, wherein said first switch unit is coupled to said lamp device and said current detecting unit, said processing unit being coupled to a node between said first switch unit and said current detecting unit.

11. The lighting assembly as claimed in claim 10, wherein said current detecting unit includes a resistor.

12. The lighting assembly as claimed in claim 8, wherein said processing unit includes:
a sampling circuit coupled to said current detecting unit and sampling the detector signal from said current detecting unit so as to generate a sampling signal; and
an average-value calculating circuit coupled to said sampling circuit and said control unit for receiving the sampling signal from said sampling circuit and for outputting the power indicating signal, which indicates an average value of the sampling signal, to said control unit.

13. The lighting assembly as claimed in claim 12, wherein the detected current flowing through said lamp device is an AC current, the detector signal is an AC signal, and said sampling circuit samples a positive half-cycle of the detector signal.

14. The lighting assembly as claimed in claim 8, wherein said first switch unit includes a series connection of a resistor and a capacitor, and a triac coupled in parallel to said series connection of said resistor and said capacitor and having a gate coupled to said control unit.

15. The lighting assembly as claimed in claim 8, further comprising:
a fan device that is adapted to be supplied with power from the external power source;
a second switch unit coupled to said fan device and said control unit and adapted to be coupled to the external power source; and
an input unit coupled to said control unit and operable so as to provide an input signal to said control unit;
said control unit being further operable to control conduction times of said second switch unit in accordance with the input signal from said input unit, thereby controlling operation of said fan device.

16. The lighting assembly as claimed in claim 15, wherein said input unit includes a mechanical switch unit.

17. The lighting assembly as claimed in claim 15, wherein said input unit includes a wireless signal transmitter, and a wireless signal receiver coupled to said control unit and operably associated with said wireless signal transmitter.
